(19) United States
(12) Patent Application Publication
(10) Pub. No.: US 2011/0305138 A1
(43) Pub. Date: Dec. 15, 2011

(54) METHOD AND DEVICE FOR CLASSIFYING TRAFFIC FLOWS IN A PACKET-BASED WIRELESS COMMUNICATION SYSTEM

(75) Inventors: Miikka Martti Einari Huomo, Espoo (FI); Marko Kenkimaki, Siuntio (FI); Jani Mikael Lammi, Espoo (FI); Juha Tapio Suojanen, Espoo (FI)

(73) Assignee: NOKIA SIEMENS NETWORKS OY, Espoo (FI)

(21) Appl. No.: 13/062,628

(22) PCT Filed: Sep. 8, 2008
(86) PCT No.: PCT/EP2008/061843

§ 371 Date: Aug. 29, 2011

(51) Int. Cl. H04W 24/00; H04L 12/26

(52) U.S. Cl. 370/230; 370/241

(57) ABSTRACT

The invention relates to a method for classifying traffic flows in a packet-based wireless communication system, said packet-based wireless communication system comprising at least one radio access network and a packet-domain core network, said method including the step of analyzing at least one data packet of at least one traffic flow through deep packet inspection at the level of the core network in order to classify the traffic flow. In order to save resources by enabling selective deep packet inspection, it is proposed that the method further comprises the steps of determining whether or not a data packet relates to at least one context out of a set of predetermined critical contexts, wherein the context is a function relating data packets to selected users, selected areas, and/or selected services, and selecting the at least one data packet for deep packet inspection if the data packet relates to one of said predetermined critical contexts.

### FIELD OF THE INVENTION

The invention relates to a method for classifying traffic flows in a packet-based wireless communication system comprising a Radio Access Network (RAN) and a packet-domain Core Network (CN). Moreover, the invention relates to a radio access network and a core network device implementing and employing the method according to this invention.

### BACKGROUND OF THE INVENTION

Exceptional and unexpected packet data traffic growth has lead to a situation where operators need to control their mobile data network usage. Faster access technologies, such as 3G and HSPA, combined with attractive charging models (flat fee, monthly subscription) is attracting more and more mobile data users. One major limiting factor in mobile networks today is the throughput (packets per second) capability. Few active heavy data users can easily congest radio cells leading to situations where the operators' network quality is perceived to be poor by all users in that specific radio cell. The network operator has no means of dynamically controlling the data usage of individual user in that specific radio cell.

A large percentage of the traffic conveyed by communications networks today consists of peer-to-peer (P2P) traffic often bypassing the operators' business logic. P2P applications use the operators' network as a pure bitpipe and the revenue may not be enough to cover the costs of carrying the traffic. P2P applications cannot necessarily be identified and classified accurately using protocol signatures, some of the popular P2P protocols even have been intentionally designed to hide in order to bypass detection.

One obvious way to improve the situation is to increase the radio network capacity and add new hardware. However, this is naturally costly for the operator and can only prolong the problem at best since data services are capacity-intensive by nature and tend to consume all the offered/available capacity.

Another method is to identify and to classify the traffic flows. Attempts to characterize traffic, to detect traffic types, with a view of classifying traffic, include deep packet inspection techniques. Proposed traditional deep packet inspection techniques, as the name suggests, assume the availability of sufficient resources to inspect entire packets in order to characterize the packets and the traffic flows the inspected packet belongs to. Therefore traditional deep packet inspection incurs high processing overheads and is subject to high costs. Conducting deep packet inspection for all users and for all services and/or traffic flows is therefore not desirable due to its demanding resource and computing requirements.

Therefore, more efficient deep packet inspection methods and devices are being actively sought by network operators in order to determine the types of traffic present in a managed communications network for traffic and network engineering purposes, online marking of packets, quality of service assessment/assurance, billing, etc. Efficient detection and classification of peer-to-peer traffic is especially desired, as peer-to-peer traffic consumes large, disproportional percentages of bandwidth and other communication network resources.

As a consequence, network operators would like to employ a combination of peer-to-peer traffic control in order to reserve network resources for other types of traffic, dynamical management of the bandwidth of peer-to-peer users or charge different rates to curb behaviour, and/or even complete blocking of peer-to-peer in accordance with regulations imposed on network operators.

Therefore there is a need to solve the above mentioned issues to provide a more efficient traffic classification through means and methods which improve the efficiency of traditional unselective deep packet inspection.

### SUMMARY OF THE INVENTION

In view of the above problems of the prior art, it is an object of the invention to provide a method and a device being capable to perform a more efficient and resource-saving traffic classification.

The invention starts from a method for classifying traffic flows in a packet-based wireless communication system. The packet-based wireless communication system comprises at least one radio access network and a packet-domain core network. The method may include the step of analyzing at least one data packet of at least one traffic flow through deep packet inspection at the level of the core network in order to classify the traffic flow.

In order to achieve the above object, it is proposed that the method further comprises the steps of determining whether or not a data packet relates to at least one context out of a set of predetermined critical contexts, wherein the context is a function relating data packets to selected users, selected areas, and/or selected services, and selecting the at least one data packet for deep packet inspection if the data packet relates to one of said predetermined critical contexts.

A critical context may for example indicate selected areas within the radio access network, e.g. a set of radio cells, that are suffering bandwidth shortages due to heavy data flows, or selected users that are transmitting high data volumes and/or selected applications that are requiring service access control.

Determining whether or not a data packet relates to at least one context out of a set of predetermined critical contexts may include conferring to a critical context table having critical context entries with identifiers for storing pre-determined critical users, areas and/or services, a function extracting out of the data packet header a user, area and/or service identifier and relating the data packet to selected users, areas, and/or services to determine the contexts associated with the data packet, and means for selecting those data packets which are related to at least one context listed in the critical context table.

A “context” may be construed as an equivalence class on the set of data packets in the network. For example, the data packets with a particular destination address, the data packets with a particular sender address and/or the data packets where the first few digits of some identifier match a pre-determined pattern constitute such an equivalence class. By focussing the DPI on the critical contexts, resources required by DPI may be reduced and the traffic classification may be performed in a more efficient way.

Moreover, it is proposed that the method further comprises the steps of identifying at least one congested context within the radio access network based on a status of bandwidth resources for the congested context, transmitting information identifying the congested context within the radio access network to the core network, and adding said congested context to the set of critical predetermined contexts.

According to the prior art, such congestion information from the radio access network is not available at the level of the core network to focus DPI on selected data packets relating to a critical context within the radio access network. Such steps are therefore especially advantageous as with this approach operators will be able to overcome the problem of identifying few heavy users congesting radio cells without having to analyse all data traffic through means of deep packet inspection.

The congested context at the radio access network may be identified based on the utilization of bandwidth resources, activity time, transmitted data volume, and/or if user is active and stationary for a long period of time.

According to a favourable embodiment of the invention, it is proposed that in the step of identifying the congested context, a radio access network device detects a congested radio cell; marks at least one packet received from the congested radio cell in a GTP-U extension header message of the packet; and forwards the marked packet to the core network to thereby transmit the information identifying the congested context. The GTP-U protocol as part of the GPRS Tunneling Protocol (or GTP) is specified by 3GPP (3rd Generation Partnership Project, e.g. see Technical Specification 3GPP TS 29.060 V8.4.0 (2008-06), which is well known to the skilled person.

The structure of GTP messages is the same, with a GTP header following the UDP/TCP header. The GTP headers contain an Extension Header (E) field which has a 1-bit value that states whether there is an extension header optional field. The Next Extension Header is an (optional) 8-bit field. This field exists if any of the E, S (Sequence Number), or PN (N-PDU number) bits are on. The field must be interpreted only if the E bit is on. The length of this extension header is stated in the Length 8-bit field, including the length, the contents, and the next extension header field, in 4-octet units. The length must be a multiple of 4. The contents of the extension header, e.g. the congestion information, may then be included in the contents field of the next extension header. It may also be sufficient just to set the 1-bit value of the E field to indicate a congested context. Furthermore, it is possible to chain several next extension headers.

As a consequence, this embodiment would not increase the signalling load between the radio access network and the core network as the information identifying the congested context would be carried with the uplink user data.

Moreover, it is proposed that the method further comprises the step of assigning bandwidth resources to at least one context of the inspected data packet according to the classification determined using the deep packet inspection. Assigning bandwidth resources to at least one context of the inspected data packet means that a function assigns the available throughput capacity for all data packets relating to the at least one context dependent on the identified traffic classes and based on a set of parameters. The parameters may include user subscription and user profile data, available network capacity, time of the day, week and/or month. Operators may thus be able to manage bandwidth resources dynamically also for traffic flows that can only be classified by deep packet inspection for selected users, selected areas and/or selected services.

Moreover, this invention proposes to execute the step of determining whether or not a data packet relates to at least one context out of a set of predetermined critical contexts at a core network gateway device being configured for providing interworking of said packet-based wireless communication system with at least one other packet data network.

The network gateway device may correspond to a Gateway GPRS Supporting Node (GGSN) in a 3GPP UMTS wireless communication system or to an Assess Gateway (aGW) consisting of two logical user plane entities, Serving Gateway and PDN Gateway, collectively called the SAE GW and one control plane entity (MME) in a 3GPP LTE/SAE wireless communication system.

A further aspect of the invention relates to a radio access network device of a packet-based wireless communication system being configured to identify at least one congested context within the radio access network based on a status of bandwidth resources for the congested context, wherein the congested context is a function relating data packets to selected users, selected areas, and/or selected services.

The radio access device may correspond to a Radio Network Controller in an UMTS 3GPP wireless communication system, a NodeB in a 3GPP HSPA+ wireless communication system, or an eNodeB in a 3GPP LTE/SAE wireless communication system.

The congested context at the radio access network may be identified based on the utilization of bandwidth resources, activity time, transmitted data volume, and/or if a session is active and stationary for a long period of time. A radio access network device is usually configured to identify sessions and/or user location, but does not store a complete user profile nor is configured to perform DPI. Advantages may be derived from transmitting the context information available at the radio network level to said network gateway device being configured for providing interworking with a other packet-based data networks and which may thus be capable of parsing together the session and user information relating to a data packet at the network location where the data packet is selected for DPI.

It is proposed that said radio access network device is further configured to transmit information identifying the congested context within the radio access network to the core network. According to a favourable embodiment of the invention, it is proposed that the radio access network device marks at least one packet received from the congested radio cell in a GTP-U extension header message of the packet and forwards the marked packet to the core network to thereby transmit the information identifying the congested context. By using GPRS Tunneling Protocol (or GTP)-U for carrying user data within the GPRS core network and between the radio access network and the core network, additional signalling may be avoided.

Alternatively, the radio access network device may transmit information identifying the congested context by means of signalling, i.e. sending a separate message directly to the core network that contains the information identifying the congested context. Message formats may include GTP-U or RANAP/GTP-C. A further alternative may be to use a network management system or a policy control server to transmit the information identifying the congested context.

A further aspect of the invention relates to a core network gateway device of a packet-based wireless communication system, said core network gateway device being configured for providing interworking of said packet-based wireless communication system with at least one other packet data network, and analyzing at least one data packet of at least one traffic flow through deep packet inspection in order to classify the traffic flow.

It is proposed that said core network gateway device comprises means for determining whether or not a data packet relates to at least one context out of a set of predetermined critical contexts, wherein the context is a function relating data packets to selected users, selected areas, and/or selected services, and selecting the at least one data packet for deep packet inspection if the data packet relates to one of said predetermined critical contexts.

Deep packet inspection analyses the data and/or header part of a data packet in order to classify the traffic flow. Header analysis includes Layer 3 (network layer) analysis categorising the traffic based on the IP header information, which includes the destination address and protocol number; Layer 4 (transport layer) analysis categorising the traffic based on the layer 3 information and the port number in the TCP and UDP headers, and Layer 7 (application layer) analysis categorising the traffic based on the L7 protocol headers. Analysing the data part include searching for protocol-specific patterns inside the data packet.

If the core network gateway device is further configured to receive information from the radio access network identifying a critical context and to add said critical context to the set of critical contexts, further advantages can be achieved. These advantages include focusing resource-intensive DPI on those data packets that are related to a critical context within the radio access network to identify the traffic flow causing the critical context within the radio access network faster and using less CPU resources.

In order to manage dynamically the bandwidth resources within the network, the core network device is further configured to assign bandwidth resources to at least one context of the inspected data packet according to the classification determined using the deep packet inspection.

A further aspect of the invention relates to a core network gateway device being configured to modify at least one charging parameter and/or service access parameter to at least one context of the inspected data packet according to the classification determined using the deep packet inspection. Such a configuration is advantageous because it would allow network operators to differentiate service access control (allowing certain services only when there is capacity in the network/cell, blocking services if services are constantly misused) or differentiated charging (price could vary depending on whether or not a data packet or a traffic flow is related to a critical context) for traffic flows that can only be classified through deep packet inspection.

### BRIEF DESCRIPTION OF THE DRAWINGS

FIG. 1 shows a schematical representation of a 3GPP UMTS packet-based wireless communication system in which the exemplifying embodiments of the present invention may be implemented;

FIG. 2 shows a schematical representation of a 3GPP LTE/SAE packet-based wireless communication system in which the exemplifying embodiments of the present invention may be implemented;

FIG. 3 shows a step-wise implementation of the exemplifying embodiment in a 3GPP UMTS packet-based wireless communication system;

FIG. 4 shows a signalling diagram for transmitting information on congested contexts; and

FIG. 5 shows a flow diagram of steps involved determining whether or not a data packet relates to a context out of a set of predetermined critical contexts.

### DETAILED DESCRIPTION OF THE EMBODIMENTS

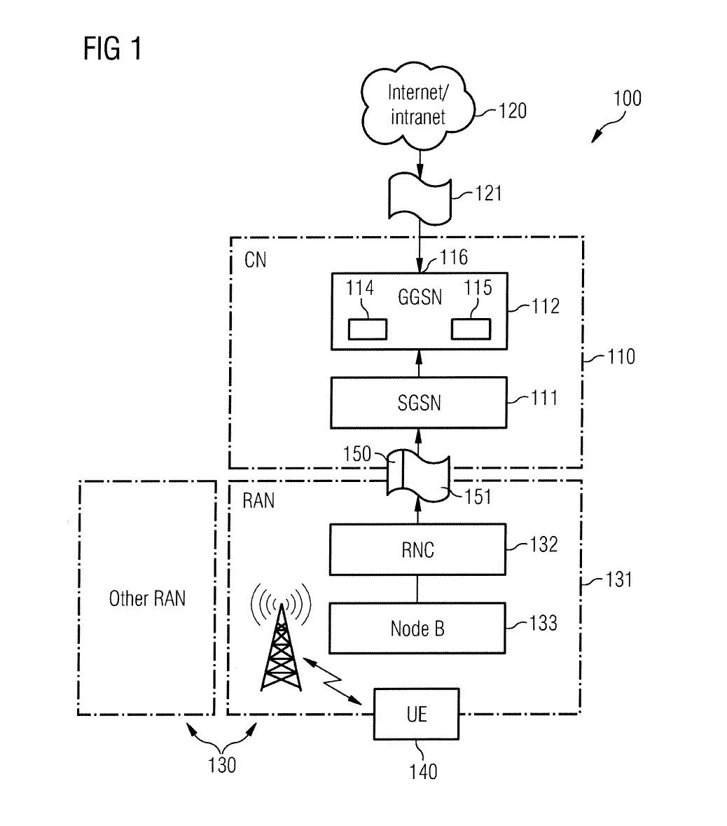

FIG. 1 shows a schematical representation of a 3GPP UMTS packet-based wireless communication system architecture 100. The wireless communication system 100 includes a core network (CN) 110 with at least one serving GPRS support node (SGSN) 111 and at least one core network gateway device, the gateway GPRS support node (GGSN) 112—The GGSN 112 comprises an interface 116 being configured for providing interworking of said packet-based wireless communication system with at least one other packet data network 120, and comprises a CPU 114 and a memory 115. The CPU 114 performs the process of selecting data packets for DPI based on a critical context table of critical contexts stored in the memory 115 and the process of analysing at least one data packet 121 of at least one traffic flow through deep packet inspection in order to classify the traffic flow. The wireless communication system 100 further comprises a universal terrestrial radio access network (UTRAN) 130 which includes one or more radio access networks (RANs) 131, radio network controllers (RNCs) 132 and NodeBs 133. The RNCs are configured to transmit congestion information from the RAN to the CN by marking a data packet 151 received from a congested radio cell using a GTP-U extension header message 150 of the packet and forwards the marked packet to the core network to thereby transmit the information identifying the congested context. The system 100 also comprises a plurality of wireless user equipment (UE) devices 140.

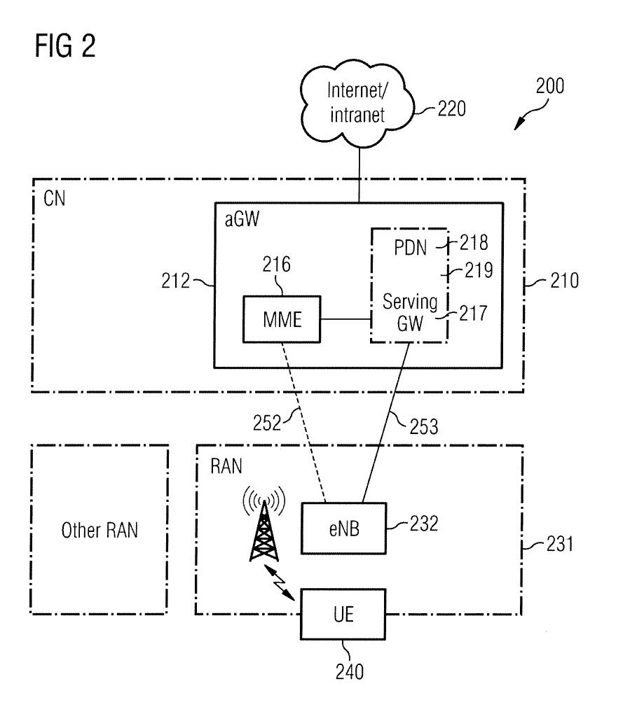

FIG. 2 shows a schematical representation of a 3GPP Long Term Evolution (LTE)/System Architecture Evolution (SAE) packet-based wireless communication system architecture 200. The following description of the embodiment illustrated in FIG. 2 focuses on the differences to the embodiment of FIG. 1. For similar and/or identical features, the reader should confer to the above description of the embodiment of FIG. 1.

The wireless communication system 200 includes a core network (CN) 210 with at least one core network gateway device, the Access Gateway (aGW) 212. The aGW 212 consists of two logical user plane entities, Serving Gateway 217 and Packet Data Node (PDN) Gateway 218, collectively called the SAE GW 219, and one control plane entity, the Mobility Management Entity (MME) 216. These may be implemented in common or separate physical nodes. The wireless communication system 200 further comprises at least one LTE radio access network 231 which includes one or more eNodeBs 232. The system 200 also comprises a plurality of wireless user equipment devices (UE) 240. The GTP user plane is shown in 253, the GTP control plane GTP-C is shown in 252.

The RAN device, the RNC 132 in FIG. 1 or the eNodeB 232 in FIG. 2 is configured for identifying at least one congested context within the radio access network based on a status of bandwidth resources for the congested context.

In contrast to prior art, the RAN device 132; 232 is further configured for transmitting information identifying the congested context within the radio access network to the core network. According to the favourable embodiment of the invention, it is proposed that in the step of identifying the congested context, a radio access network device detects a congested radio cell; marks at least one packet 151 received from the congested radio cell in a GTP-U extension header message 150 of the packet; and forwards the marked packet to the core network to thereby transmit the information identifying the congested context. As a consequence, this embodiment does not increase the signalling load between the radio access network and the core network as the information identifying the congested context would be carried with the uplink user data.

The CN gateway device, i.e. the GGSN 112 in FIG. 1. and the aGW 212 in FIG. 2, is configured for providing interworking of said packet-based wireless communication system with at least one other packet data network 120; 220 and analysing the incoming traffic flows through deep packet inspection. The CN gateway device is further configured to extract the information on the congested contexts within the RAN from the GTP-U extension header messages. DPI is conducted selectively only for those incoming data packets that related to one of the identified critical contexts.

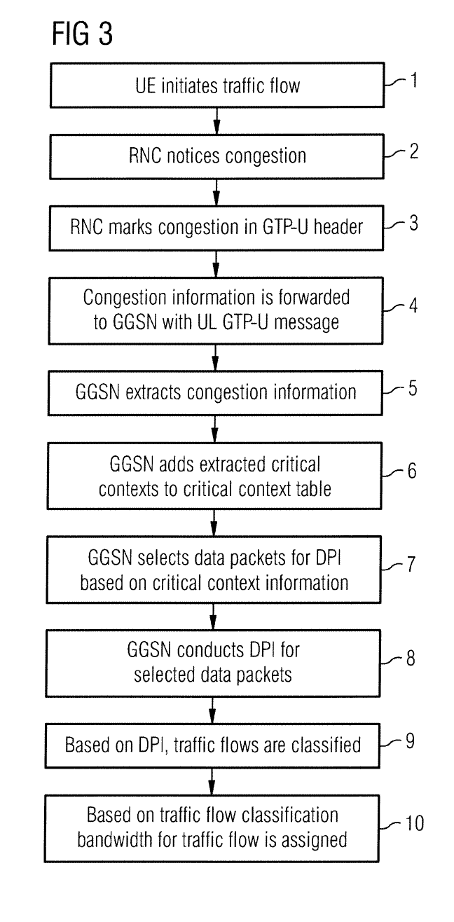

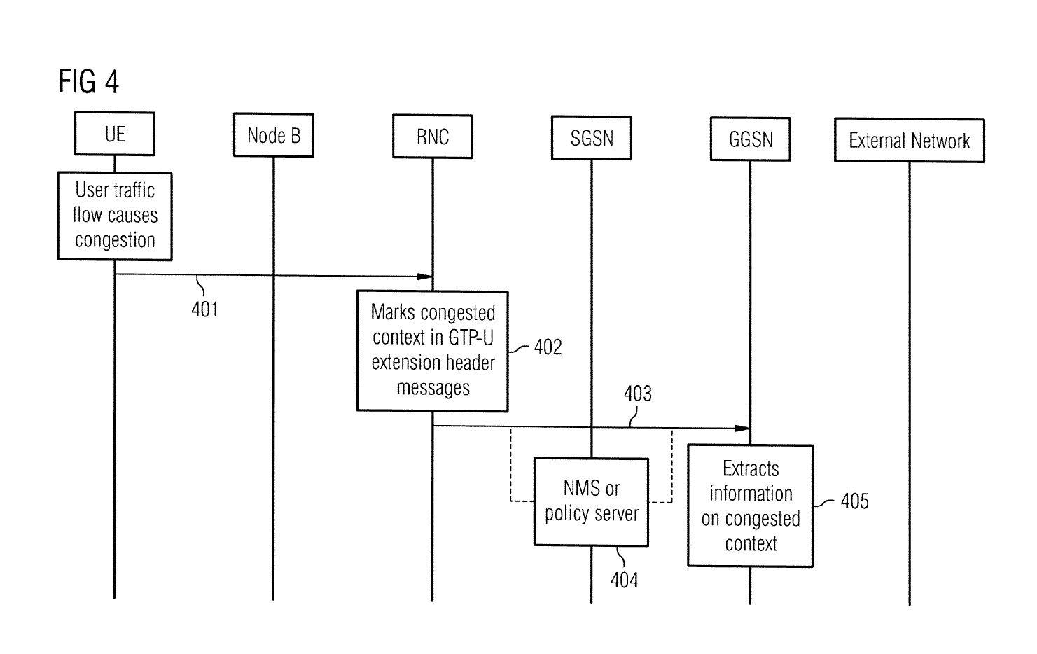

FIG. 3 describes the steps for selective DPI in accordance with the embodiment from FIG. 1 based on an illustrative example. In step 1, a user initiates a P2P download resulting in a traffic flow congesting his radio cell within the radio access network. In step 2, the RNC notices the shortage of bandwidth resources in that radio cell, e.g. if the traffic volume exceeds a threshold value dependent of the available throughput capacity. As set forth at step 3, the RNC marks the packets of the traffic flows received from the congested radio cell in a GTP-U extension header message of the packet; and forwards in step 4 the marked packets to the GGSN via the corresponding SGSN to thereby transmit the information identifying the congested context. The congestion information would thus be carried with the uplink (UL) user data. This is also illustrated in FIG. 4 that shows a signalling diagram for transmitting information on congested contexts. The RNC receives the uplink user data 401 and adds the congestion information in the GTP-U extension header 402 before the GTP-U message is transmitted to the GGSN 403.

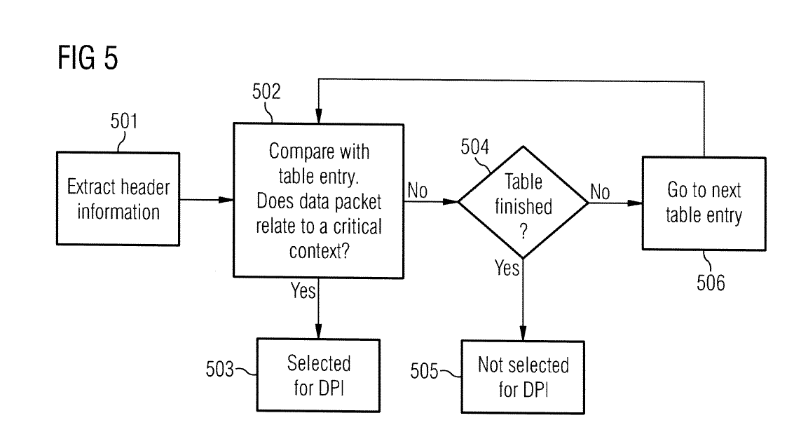

In step 5 of FIG. 3, the GGSN is configured to extract the information on the congested contexts within the RAN from the GTP-U extension header messages and, as indicated in step 6, to add the extracted critical context to a table that stores all the information on the critical contexts as indicated. The GGSN is further configured to delete out-dated critical contexts from the table of critical contexts, e.g. by a function that deletes all context entries in the table that have not been indicated as critical contexts for a period of time. As set forth at step 7, the GGSN selects the data packets for DPI based on the entries of the critical context table. FIG. 5 describes in more detail the steps to determine whether or not a data packet of a traffic flow is selected for deep packet inspection. In step 8, the GGSN conducts deep packet inspection only for those incoming data packets that relates to one of the critical context as determined in step 7. According to the findings of the DPI, the data packets of a traffic flow are then classified in step 9. For example, if the traffic flow contributing to the congested radio cell indicated by the RNC is identified as P2P traffic, then the traffic flow may be classified as P2P traffic and/or as un-wanted traffic.

In step 10, the GGSN then adjusts the bandwidth resources available to this un-wanted traffic according to a function that determines the bandwidth resources based on the identified traffic classification, user profile and status of network resources.

A further aspect of the invention relates to a CN gateway device being configured to modify at least one charging parameter and/or service access parameter for the traffic flow according to the classification determined using the deep packet inspection in a modified step 10 in FIG. 3. Such configuration it would allow network operators to differentiate service access control (allowing certain services only when there is capacity in the network/cell, blocking services if services are constantly misused) or differentiated charging (price could vary depending on whether or not a data packets is related to a critical context) for traffic flows that can only be classified through deep packet inspection.

FIG. 5 illustrates a flow diagram of steps involved in determining whether or not a data packet relates to a context out of a set of predetermined critical contexts. The GGSN extracts in step 501 from the data packet header the information to identify the user, area and/or service to which the traffic flow relates. The GGSN then compares this information to a first entry in a critical context table in step 502. If the data packets relates to a critical context determined by the first entry, then the data packet is selected for DPI in step 503. Otherwise, it is checked whether the table of critical contexts has additional entries in step 504. If not, then data packet is not selected for DPI in step 505. If yes, then the procedure jumps to the next entry of the critical context table in step 506 and compares this entry with the information extracted from the data packet header in step 502.

It is understood, that the present disclosure has been made only by way of example, and that numerous changes in the details of implementation of the invention may be made without departing from the spirit and scope of the invention as defined in the independent claims. For example, the RAN device may alternatively be configured to transmit the information identifying the congested context by means of signalling, i.e. sending a separate message directly to the core network gateway device by using GTP-U or RANAP/GTP-C as a message format. Or, as illustrated in 404 of FIG. 4, congestion could be indicated by means of a network management system that may receive and explicit congestion message from RAN or being configured to make a decision based on network load. Another alternative to transmit information on congested context may be to use a policy server which could combine congestion and user subscription information. The invention could also be implemented in other 3GPP wireless communication systems (e.g. in an HSPA+ system where the iNodeB represents the radio access network device that identifies and transmits the information on the congested contexts) or in non-3GPP wireless communication systems. Moreover, the method could also be employed to perform selective DPI on uplink traffic flows.

The skilled person will easily be able to find further combinations and/or sub-combinations of the above described features of the invention in order to adapt the method and the devices to specific circumstances while using the central aspects of the invention as defined in the claims.

1. Method for classifying traffic flows in a packet-based wireless communication system, said packet-based wireless communication system comprising at least one radio access network and a packet-domain core network, said method including the step of analyzing at least one data packet of at least one traffic flow through deep packet inspection at the level of the core network in order to classify the traffic flow,
wherein the method further comprises the steps of:
a. determining whether or not a data packet relates to at least one context out of a set of predetermined critical contexts, wherein the context is a function relating data packets to selected users, selected areas, and/or selected services, and
b. selecting the at least one data packet for deep packet inspection if the data packet relates to one of said predetermined critical contexts.

2. Method according to claim 1, further comprising the steps of:
a. identifying at least one congested context within the radio access network based on a status of bandwidth resources for the congested context,
b. transmitting information identifying the congested context within the radio access network to the core network, and
c. adding said congested context to the set of critical predetermined contexts.

3. A method according to claim 2, wherein the step of identifying the congested context, a radio access network device
detects a congested radio cell
marks at least one packet 151 received from the congested radio cell in a GTP-U extension header message of the packet; and
forwards the marked packet to the core network to thereby transmit the information identifying the congested context.

4. Method according to claim 1, further comprising the step of assigning bandwidth resources to at least one context of the inspected data packet according to the classification determined using the deep packet inspection.

5. Method according to one of the preceding claims claim 1, wherein the step of determining whether or not a data packet relates to at least one context out of a set of predetermined critical contexts is executed at a core network gateway device being configured for providing interworking of said packet-based wireless communication system with at least one other packet data network.

6. A radio access network device of a packet-based wireless communication system being configured to identify at least one congested context within the radio access network based on a status of bandwidth resources for the congested context, wherein the congested context is a function relating data packets to selected users, selected areas, and/or selected services, wherein said radio access network device is further configured to transmit information identifying the congested context within the radio access network to the core network.

7. A core network gateway device of a packet-based wireless communication system, said core network gateway device comprising:
a. an interface providing interworking of said packet-based wireless communication system with at least one other packet data network, and
b. means for analyzing at least one data packet of at least one traffic flow through deep packet inspection in order to classify the traffic flow, wherein said core network gateway device further comprises means for:
c. determining whether or not a data packet relates to at least one context out of a set of predetermined critical contexts, wherein the context is a function relating data packets to selected users, selected areas, and/or selected services, and
d. selecting the at least one data packet for deep packet inspection if the data packet relates to one of said predetermined critical contexts.

8. A core network gateway device according to claim 7, wherein said core network gateway device is further configured to receive information from the radio access network identifying a critical context and to add said critical context to the set of critical contexts.

9. A core network gateway device according to claim 7, wherein said core network gateway device is further configured to assign bandwidth resources to at least one context of the inspected data packet according to the classification determined using the deep packet inspection.

10. A core network gateway device according to claim 7, wherein said core network gateway device is further configured to modify at least one charging parameter and/or service access parameter to at least one context of the inspected data packet according to the classification determined using the deep packet inspection.
